(19) United States
(12) Patent Application Publication
(10) Pub. No.: US 2016/0203702 A1
(43) Pub. Date: Jul. 14, 2016

(54) Wireless Surveillance System Having Obviated the Need for Battery Replacement and Method for Controlling Wireless Device

(71) Applicant: Ruoping DU, Guangzhou, Guangdong (CN)

(72) Inventors: Du RUOPING, Guangzhou (CN); Qiwei XIAO, Fremont, CA (US)

(21) Appl. No.: 14/441,890

(22) PCT Filed: Nov. 14, 2013
(86) PCT No.: PCT/CN2013/087094

§ 371 Date: Jul. 28, 2015

(30) Foreign Application Priority Data
Nov. 14, 2012 (CN) 201210461152.2

(51) Int. Cl. G08B 25/10; G08B 25/00

(52) U.S. Cl. CPC G08B 25/10; G08B 25/008

(57) ABSTRACT

Disclosed is a wireless surveillance system comprising a probe (200) and a control center, obviating the need for battery replacement, and completely powered by solar energy. During disarmed periods, the probe (200) ceases to probe the external thereof, and ceases to transmit data to the control center. A receiver (201) of the probe (200) works in consecutive turned-on/turned-off modes. A turned-on time of the receiver (201) is greater than or equal to the power-up latency time of the probe (200). The receiver (201) is provided without frequency changer, intermediate frequency band-pass filter, and low frequency band-pass filter. The probe (200) comprises a human-machine interface (209) for use in displaying light intensity. Also disclosed is a method for controlling the operation of a wireless device. The receiver (201) is controlled by a trigger signal to work in the consecutive turned-on/turned-off modes, where the turned-on time is greater than or equal to the power-up latency time of the receiver (201). A transmitter (205) first transmits a constant amplitude and continuous signal. The receiver (201) uses an amplitude threshold and a time threshold to detect the signal. By having the receiver (201) provided without frequency changer and intermediate frequency low-pass filter, and by having a super-regenerative receiver provided without low-pass filter, the power-up latency time of the receiver (201) is reduced to implement reception, while a frequency stabilization element having a high Q value is employed to implement frequency stabilization on a position away from the center frequency of the frequency stabilization element.

### TECHNICAL FIELD

The present invention relates to surveillance alarm system. Moreover, it relates to a wireless surveillance alarm system using solar power without replacing battery, and a method of controlling wireless devices.

### BACKGROUND ART

A surveillance alarm system includes at least a probe and a control center, being used at home, in office. In a special time which named armed time, if someone enters an area where is monitored by the probe, the control center will send a intrusion information to such as police office, security office, even to any a computer, a phone that connected internet. Beside the armed time which named disarmed time, the control center does not transmit the intruder information. Here, the surveillance alarm system means a intruder alarm system.

A traditional probe comprises of a sensor and a radio transmitter.

An existing wireless intruder alarm system and relative parts are shown in the FIG. 1. The wireless intruder alarm system 104 comprises of a number of probes 101, 102, 103, used to gather information and a control center 100 to process information. The control center 100 accesses network 105, such as internet, making a connection with external networks 107, 108. Using a hall sensor 101a and a radio transmitter 101b, forms a window and door probe 101. Using a passive infrared sensor and a radio transmitter 102b, forms a moving probe 102. Using a image sensor 103a and a radio transmitter 103b, forms a camera 103, etc. When the sensor of the probe senses any abnormal information, radio transmitter will send information to the control center. If it is armed time, the control center will judge that is an intrusion, otherwise, if it is an unarmed time, the control center will ignore the information. The armed time and the unarmed time can be set by the user and execute automatically or manually. For example, a user can set the alarm system go into armed time after 11 p.m. and go into unarmed time after 6 a.m. every day automatically. Also he can make the alarm system into unarmed time before entering his house and make the alarm system into armed time when leaving his house manually with a remote controller.

If an intrusion is judged, the control center will take actions below: controlling buzzer to send a loud sound. by wire (for example :telephone) or by wireless (for example mobile phone), transmitting the intrusion information to net 105, 106, 109, then to wherever assigned, such as security company 108, police station 107, even to the cellphone 112, the ipad 111, the computer 110 which belong to the owner of intruder alarm system. Above illustrate a typical process of a wireless intruder alarm system.

### Technical Problem

In the existing intruder alarm system, each probe is connected the control center with wire or wireless.

Wiring causes trouble, and is not good looking. Wireless overcomes the disadvantages of wiring. However, unfortunately, it has another disadvantage. The wireless probe must be equipped with batteries. Therefore, users need to replace the batteries. Normally, for good looking and the detecting angle, probes will be installed at a high place. Every time when the batteries are to be replaced, the user should climb high. That is obviously not glad. Also, the discard batteries contaminate the environment. There is no such an approach that has both advantages of the wire and the wireless up to now. The present invention will solve the problem: without wiring while installing and without replacing battery.

Sensitivity of the sensor is often in conflict with false alarm. Increasing the sensitivity will generate more false alarms. For instance, after increasing the sensitivity of moving sensor, movements of little animal may trigger the sensor. Decreasing the sensitivity to reduce false alarms caused by the little animal, may shorten the detection distance. It is hard to balance sensitivity and false alarm. Therefore, in an attempt to keep high sensitivity, the false alarms are inevitable. Users need to confirm whether it is a false alarm when an alarm comes. Viewing the photo taken by the image sensor at this time can help to do that well. Working with other sensors, imagine sensor provide convenience on eliminating the false alarms.

The present window and door probe, bases on a magnet getting close to a reed switch. It almost consumes no current. The working current of the moving sensor (passive infrared sensor) is quite low, lower than 2 uA. The working current of imagine sensor is high, which is larger than 100 mA. Some infrared diodes being powered on as photograph illumination at night will cause much more current. In the present invention, there is no need for imagine sensor keeping working and recording data. The imagine sensor in the present invention cooperates with other sensors, is triggered, turned on by the other sensors instead of working alone. The imagine sensor is about to be turned on and works under only two cases below:
(1) When users occasionally ask for a photo to view.
(2) After sensing an intrusion, take a photo to eliminating the false alarms.

Practically, the chance of these two cases is low. so the imagine sensor works seldom, and it consumes little power. The power consumes mainly in the generation of intrusion information, generation of imagines, and the sending of imagines.

we have

conclusion 1: that sensors barely consume power in detection state while the generating of information and transmission consume most of the power.

In the tradition wireless intruder alarm system process, the information of probe is one-way, regardless of it is in the armed or unarmed time. When having sensed intrusion, the intrusion information is transmitted to the control center. Whether the control center takes action or not, depends on the alarm system being in armed or disarmed time. For example, information will be transmitted to the control center as soon as the movement sensor senses the movement of human. The control center will take action or ignore according the state of the system.

Nowadays, solar power technology is being developed. Solar cell can be the power source of device. Here solar power not only mean the power from direct sunlight, but also all the power from all kinds of rays in daily life. If solar cell can provide all the power, the target without wiring and without replacing battery can achieve.

Because some of the probes are installed indoor, the illumination intensity is not quite strong. Considering the looking, the area of the solar cell may not to be too large. The output energy of solar cell is proportional to the illumination intensity and irradiated area. Illumination intensity and irradiated area are limited here, the hardship that solar cell provides the entire energy of probe still remains up to now.

The present invention achieves the target by decreasing consumption of the probe.

### Technical Solution

To overcome the inconvenience of traditional intruder alarm system, the present invention provides a wireless surveillance system without battery replacement, comprising of at least a probe and a control center, said probe at least has a receiver, a transmitter, a timer, a sensor and a control circuit;

said receiver of the probe is controlled by the timer, operating in a continuous turned on/turned off mode: when it's time for said timer to turn on said receiver, the receiver will be turned on and waits for receiving the signal sent by said control center, the power-on time period is longer than or equal to power-on latency time of the receiver; after lasting for said power-on time period, said timer turned off the receiver until lasting for a power-off time period, then the timer will restart another turned on/turned off period.

Said on/off mode is self-adaption, and the timing of said timer varies, the power-off time varies according to the time in a day.

Said probe further comprising of a solar cell, a storage battery; solar cell is used as energy source; when light is strong, the solar cell provides the probe working current and charges the storage battery; when it is darken, the storage battery provides the probe working current.

Said probe can receive an order to change state from being disarmed to being armed or contrary; during the disarmed time, the control circuit of said probe turns off the sensor, and the transmitter, stops sensing the surrounding and the data transfer.

Said receiver of the probe first check whether there is signal in the channel when being turned on,

if not, receiver is turned off immediately, waiting until the next being turned on by the timer (202);

if there is, the probe keeps power-on and measures the duration of the signal, if the duration is greater than a certain threshold, the probe keeps power-on one more to receive the complete signal sent by the control center, or the receiver is turned off immediately, waiting until the next being turned on by the timer (202).

Said receiver has been shortened power-on latency time to less than 500 us.

Said receiver has no frequency changer, no intermediate frequency band-pass filter, and has no low-pass filter.

Said receiver of the probe is a super-regenerate receiver without low pass filter.

Said super-regenerate receiver has oscillator, timer, envelope detector, counter, comparator, memory and average value circuit; all these circuits are embedded into a microprocessor MCU.

Said oscillator has a high Q factor component to stabilize frequency.

Said oscillator works in the frequency offsetting the center frequency of the high Q factor component.

Said probe includes a human-machine interface indicating the current level of light.

The present invention provides a method of controlling a wireless device comprising a receiver, a timer, a control circuit. the method comprises: a trigger signal of the timer controlling the receiver working continuously in turned on/turned off mode: when in on state, turning on the receiver into receiving for a time period that is equal to or longer than the power-on latency time of the receiver; when in off state, turning off the receiver or triggering the receiver into sleep.

The wireless devices further comprises a transmitter, first transiting a constant amplitude signal for a time period which is longer than the power-off time of the receiver, then transiting the data content.

The receiver first checks existence of the signal while being turned on; if inexistence, turning off the receiver immediately and waiting for the next time of being turned on; if existence, keep the receiver being powered on and measures the duration in which the signal amplitude does not change, if the duration is longer than a certain threshold, keep being powered on to receive the complete data content sent by the transmitter, or it will be turned off immediately, waiting until the next time of being turned on.

The power-on latency time of the receiver is shortened to less than 500 us.

The probe employs the receiver without frequency changer, intermediate frequency, band-pass filter and low-pass filter to receive the signal.

The probe employs the super-regenerate receiver without low -pass filter to receive the signal.

The receiver further comprises a oscillator having a high Q factor component to stabilize frequency.

The oscillator of receiver is tuned to oscillate in the frequency offsetting the center frequency of the high Q factor component.

### Advantageous Effects

All the aspects about the present invent helps reducing the probe consumption sharply, which is tremendously less than the present probe one. Based on this, power generated by the solar cell is more than the power consumption of the probe, which means only the solar cell can feed up probe's power needs. Therefore, probe does not need to change battery anymore and its external appliance can always work without any energy input. The target that no wiring while installing and no need changing battery while using is reached by the low-consumption probe, which is convenient and environmental-friendly.

### DESCRIPTION OF THE DRAWINGS

FIG. 1. is the structure of the existing intruder alarm system and its relative working part

FIG. 2. is the structure of probe in the present invention

FIG. 3. is the signal relation between the control center and the probe receiver.

a signal that turn on/turn off the receiver of the probe

b signal sent by the control center

c the improved signal sent by the control center

FIG. 4. is the format of the signal sent by the control center

a. The signal content sent by the control center

c. the receiver has received the signal

d. the receiver has not received the signal

FIG. 5 is the structure of a tunable receiver.

FIG. 6 is structure of a super-regenerative receiver.

FIG. 7 is the signal graphs of a super-regenerative receiver.

A The waveform of RF input 601

B The waveform of quench control signal 603

C The output waveform of oscillator 602

D The output waveform of envelope detector 604

E The output waveform of low-pass filter 608

FIG. 8 is the structure of the improved super-regenerative receiver.

FIG. 9 is a receiving flow diagram of the improved super-regenerative receiver.

FIG. 10 is a graph of HMI (human-machine interface)

FIG. 11 is a schematic of power-on latency time.

A The signal sent by the control center

B The output signal of the probe timer, it will control the receiver to work in on/off mode

C The output of the probe receiver.

### BEST MODE

From the conclusion 1, the power consumption of the probe is little when the sensors are in detecting state. It is mainly consumes in the information transmittance. When the intruder alarm system is in armed time, it can be inferred that people action is little in the surveillance area. For example, in a company, when in closing time, the intruder alarm system is in armed time, because no people action, the chance that sensor has sensed movements and the information is transmitted to the control centers is few. So the power consumption is low. When in unarmed time, the people movements in surveillance area might be frequently. For example, when in business hours, chance that people movement has been sensed in the surveillance area increase, the sensors will sense the movements frequently, and the probe sends information to the control center frequently, which generates much more power consumption through the transmitter.

So we get

The conclusion 2: the probe consumes little power during armed time. It mainly consumes power when transmitting during unarmed time.

Making the sensors and the transmitter stop working and sleep during unarmed time, based on the conclusion 2, the power consumption will decrease sharply. However, it causes a problem: when is the time for the probe to be armed, and when to be disarmed? Perhaps, timing maybe a way, but users may change state manually. For example, users might use a remote control to change the system state from being unarmed to being armed while leaving home. Or, users may want to view the photo taken by the imagine sensor from a distance at any time. Timing can not satisfy these two flexibility needs.

The probe should be active from sleep at once. Then the above-mentioned one-way probe must have a receiver to receive the instructions to change its state immediately. The probe becomes two-way, its receiver must keep working. Now the lowest power consumption receiver has a voltage under 3.6V, current around 300 uA. Then the current consumption of the receiver one day will be ≈0.3*24=7.2 mA.h. Comparing with the current consumption during unarmed ≈0.4 mA.h. The current consumption of the receiver is more than increase. So turning off the sensors but adding a receiver seems to be can not reduce the power consumption. Furthermore, the solar cell said above, generates the current around 0.25 mA.h one day, that can not offer enough power to the receiver.

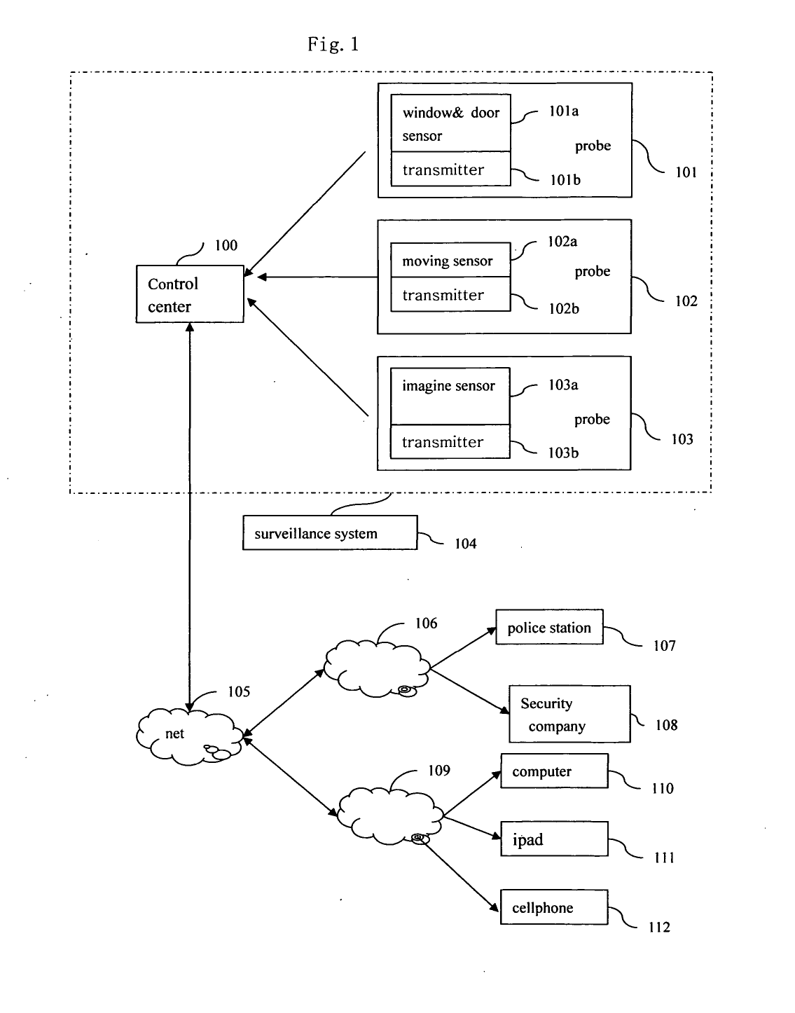

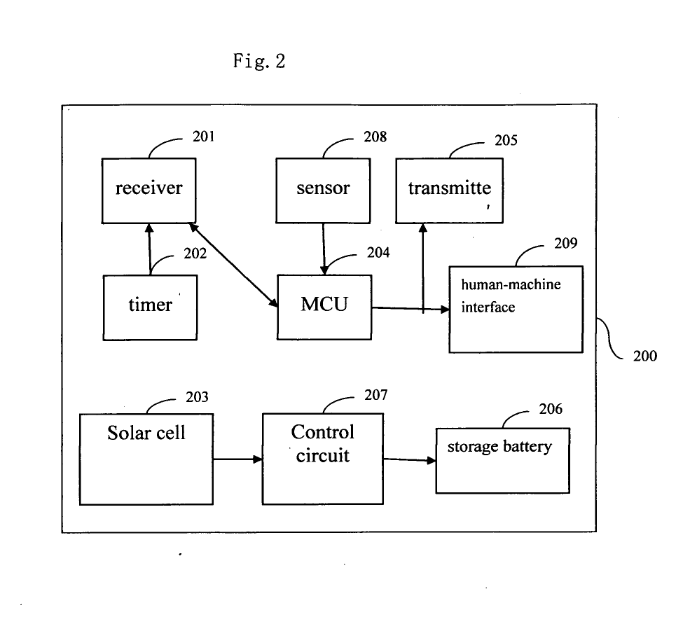

The main difference between the intruder alarm system provided by the present invention and the exiting which is shown as 104 in the FIG. 1 is the probe. As shown in the FIG. 2, take an example of the moving probe 200, compared with the present probe 102 in the FIG. 1, it adds a receiver 201, a timer 202 for controlling receiver, MCU 204 (micro control unit) and the 203,206,207 for solar power charge control.

The present invention can reduce the probe power consumption by more 10³ than the exiting. The key is to reduce the power consumption of the receiver. With the low-power consumption receiver keeping working, the MCU 204 in the probe knows when to be armed and when to be unarmed, it can turn off the sensors and transmitter during unarmed time. According the conclusion 2, the probe power consumption will have a great reduction. Hence, the essence of the present invention is to realize a low-power consumption receiver.

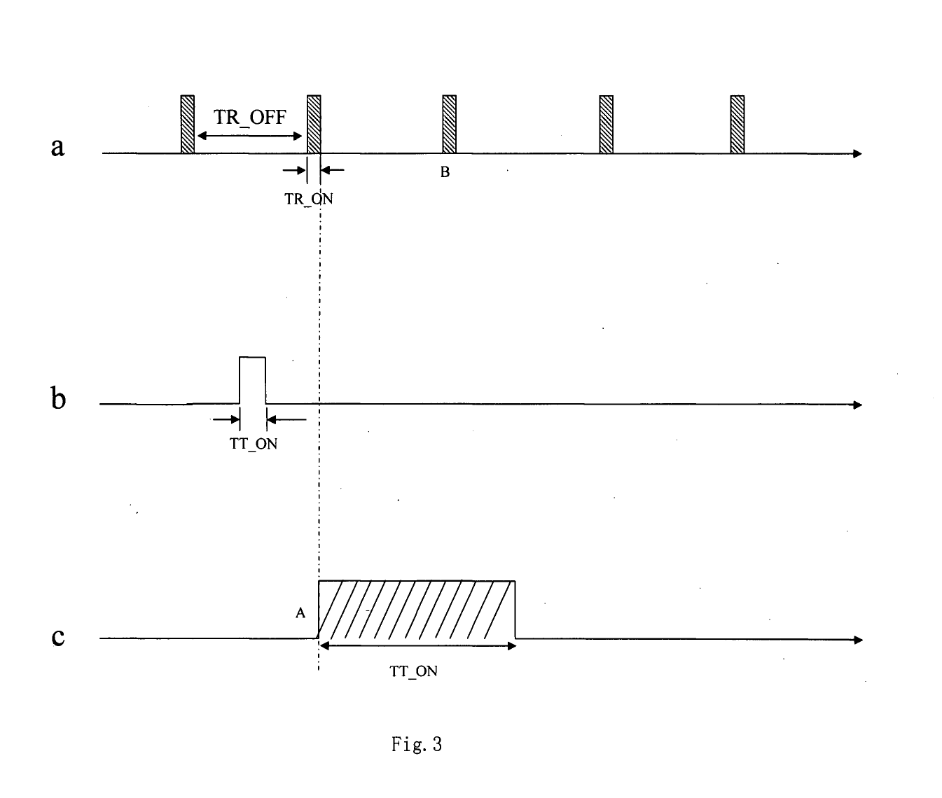

To achieve the target, in the first aspect, the receiver 201 of the probe is controlled to keep on working in on/off mode. The high level what the timer 202 outputs turns on the receiver 201 of the probe. The low level what the timer 202 outputs turns off the receiver 201. The time period when the probe receiver 201 is turned on=TR_ON, and the time period when the probe receiver 201 is turned off=TR_OFF. As shown in the FIG. 3(a), when probe receiver is turned off, the energy supply is cut off, except the timer 202 and the sensor 208. The other parts of the probe go into a sleep state all the time. The probe 200 only consumes little energy. The receiver consumes most of energy of the probe during power-on time. Compared with mode of turning on the receiver all the time, the probe average energy consumption in turning on/off mode reduces as:

TR_ON/(TR_ON+TR_OFF)≈TR_ON/TR_OFF (1)

(When TR_ON is far less than TR_OFF, this condition is satisfying in the present invention.)

The shorter TR_ON, or the longer TR_OFF, can both reduce the average energy consumption of the receiver.

When the control center 100 transmits signals to the probe 200, the transmitter 106 will be turned on, as shown in the FIG. 3(b). The transmission time=TT_ON. Generally, because the contents sent from the control center 100 are few, so TT_ON is short. If the control center 100 sends signals just right in the receiver 200's power-off time, the receiver 201 will not receive the signals, as shown in the FIG. 3(b).As a result, when the control center 100 is about to send considerable data, the transmission time TT_ON must be extended until

TT_ON≧TR_OFF, (2)

So that it can ensure that the signal can be received. Therefore, as shown in the FIG. 3(c), the period of what the control center 100 needs to send in must be at least longer than TR_OFF. If not longer, the transmitting content should be transmitted continuously and repeatedly, until the transmission time is longer than the sensor 200's power-off time (TR_OFF).

The responsive time of the receiver will delay because of turning off the receiver for a period of time TR_OFF. As shown in the FIG. 3(c), after the control center send an order at point A, under the worst condition, the receiver in the FIG. 3(a) does not receive the signal at point B and until delay almost a TR_OFF. Therefore, the longest delay after sending order=TR_OFF. In order to reduce the power consumption, TR_OFF need to be delayed as long as possible. However, once TR_OFF delays too more, when the users need to change the intruder alarm system state manually, the responsive delay can be felt by the users, and leaving a bad impression such as button bad contact. So the “ON/OFF” mode will be limited by people feeling. Under this restriction, to have a maximum power-off period of TR_OFF, the ON/OFF mode can be self-adaption, which means that TR_OFF is not a fix value. In the daytime, the users might change the state of the alarm system. To provide user with a better using experience, TR_OFF is shorter, like less than 1 second, having a quick response. At deep night, it might be impossible for users to change the states of the alarm, so TR_OFF can be a bit longer, such as 5 seconds. As a result, the power consumption will reduce by five times.

In order to explain the technique method of the present invention with concrete data, assume that the power-off time of receiver is

TR_OFF=1500 ms (4).

Apparently, this data is just for our convenient to explain clearly, but not a technical quantitative feature of the present invention. According to the equation (2) and the equation (4), the continuous transmission time period:

TT_ON>1500 ms (5)

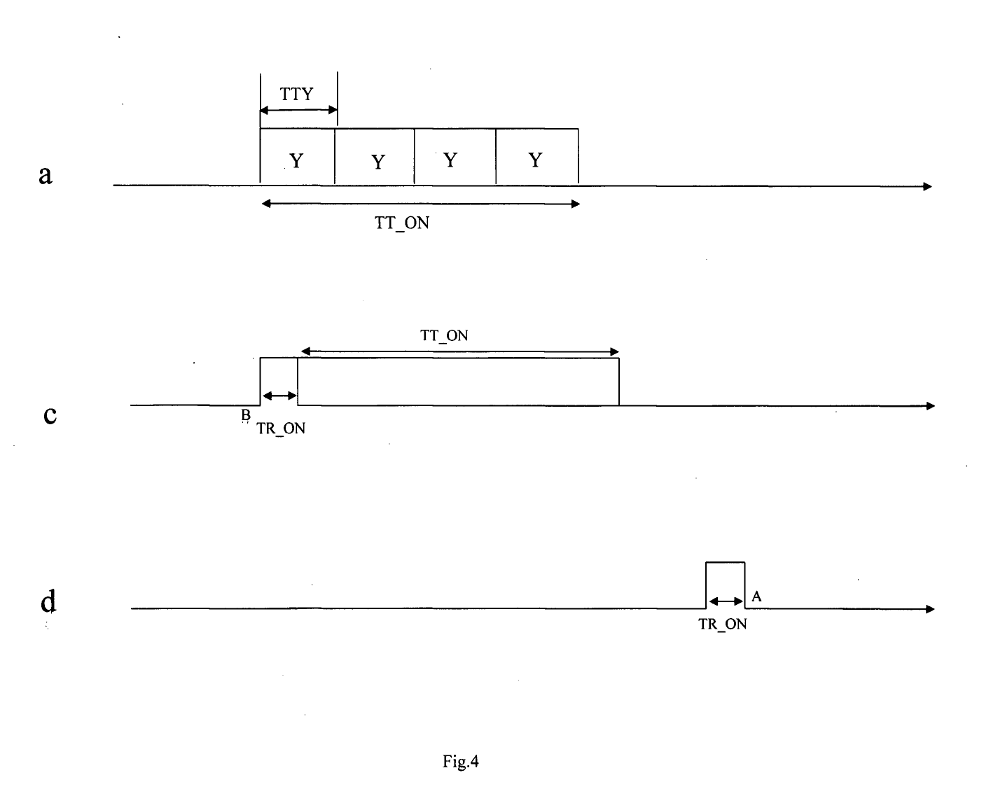

To prevent interference, content sent by the control center contains address codes. Each intruder alarm system has a different address codes. The control center and the probe belonging to a same intruder alarm system have a same code. The code at least has several bits. The probe only makes a response while receiving the same address code coming from the control center. The sent signal containing at least the address code is named “Y” signal. That is a data package, and time period to send this “Y” signal=TTY. TTY at least lasts for some bits time period. If employing the ON/OFF approach above, Y signal must be continuously sent during TT_ON, as shown in the FIG. 4(a).To receive a whole Y signal, TR_ON, the power-on time period of the receiver 201, must longer than twice of the length of the Y signal which called TTY. That is:

TR_ON≧2*TTY (6)

Because the worst case is that the receiver 201 is turned on just after the control center 100 has begun sending “Y” signal, the probe 200 will have to wait until this “Y” signal finish being sent and then receive the next whole “Y” signal. To consider this, TR_ON≧2*TTY, but not TR_ON≧TTY.

Assume that Y signal has N bits, and signal transmission baud rate=1/T, then the time that need to send “Y” signal TTY=N*T. According to equation (6), each time when the receiver is power-on:

TR_ON≧2*N*T (7)

According to (7), assume reasonably TR_ON=30 ms, according to the equation (1) and (4), the power consumption becomes one fiftieth (30/1500) of before. Rely on delaying TR_OFF, the receiver power consumption has reduced greatly.

The ON/OFF mode of the present invention is based on the self-adaption. A simple ON/OFF mode can not reduce so much of the power consumption, because it is restricted by human feelings. The ON/OFF mode of the present invention has a breakthrough on human feeling restriction. With self-adaption, the ON/OFF mode can be realized in probe effectively.

In the second aspect of present invention, improve the strategy of sending and receiving, shorten TR_ON to reduce more average power consumption of the receiver. Delaying TR_OFF is explained above. To cut down TR_ON will be realized below.

To achieve the target, two explorations will march.

The signal sent in the present invention is no longer the Y signal repeatedly sent in the FIG. 4(a), but a X signal and at least one Y signal in the FIG. 4(b). X signal is a continuous RF signal which does not change its carrier amplitude during being sent. The duration of X signal must longer than or equal to the power-off time of the receiver. To guarantee receiving, X+Y like this can be sent by the control center several times.

The first exploration is amplitude threshold.

For the probe receiver 201, now every time when it is turned on, it does not receive and search for Y signal, but receive and search for X signal. That means at this time the receiver only cares about signal amplitude and ignores other signal characteristics such as phase, and frequency offset etc., let alone code format and code content. The receiver is turned on tentatively for a moment. Now the behavior of the receiver just likes an AM receiver. Since the time period sending X signal is longer than or equal to the power-off time of the receiver, every time when the control center is sending the X signal, there must be a moment in which the receiver is turned on and can capture the X signal. When the receiver is turned on, if the receiving signal amplitude is over a threshold, it will be judged that there is X signal is sent and in the channel. The threshold is an amplitude threshold. Actually, there are two possibilities
(i) As shown at point B in the FIG. 4(c), it receives a X signal, then the receiver will keep turning on for a time period of TR_ON. At this time, according the format of the control center, such as modulation, encoding, the receiver searches and receives the Y signal. Later it will be turned off and restart a next cycle of ON/OFF.
(ii) As shown in the FIG. 4(d), the receiver has not received signal. Then the receiver will be turned off immediately and restart a next cycle of ON/OFF.

Only when the control center changes its state and sends information to the probe, situation (i) appears. There is few chance every day for the control center sending signals while there is a lots of opportunities of situation (ii) appearing. Hence, to indicate the present invention more clearly and simplified, ignoring the power consumption under situation (i) and only considering situation (ii), the power-on time of receiver TR_ON now means the time period that the receiver receives and checks whether there is any signal in the channel. It can be less than a bit time period. So the equation (7) becomes to: TR_ON ≦T, TR_ON lowers by 2N times, and according to equation (1), its average power consumption also will lower by 2N times.

Considering situation (i), start the second exploration. In situation (i), after judging there is signal, normally the receiver will keep the power-on for a time period to receive a complete data package. The time period lasts for at least the time of data package lasting (time of the Y signal). The present invention starts the second exploration here. Because there is noise in the channel inevitably, if the amplitude threshold mentioned above is set low a little, the probe receiver will be triggered often by the noise. Then it will be incorrectly judged that there is a signal in the channel at this time and search data generating additional power consumption. However, if the amplitude threshold is set high a little to avoid the effect of the noise, signal may be lost, the sensitivity will decrease. It is hard to make a choice, to obtain a high sensitivity, and not to increase much extra power consumption. The second exploration in the present invention solves the problem. As said above, the X signal is the prefix part of the signal sent by control center, one of X signal characteristics is that the lasting period is longer than or equal to the receiver power-off time without amplitude changing. It means the X signal cause a signal with stable amplitude is received. This receiving signal lasts a period that is much longer than the period that the noise trigger and last for. In the situation of (i) above, with high sensitivity, after judging there is a signal in the channel, keep the receiver power on and test how long the signal lasts for. Define a time threshold, while the signal lasting period is longer than the time threshold, the signal will be judged as an X signal and the probe receiver keeps power on to receive Y signal. When the signal lasting period is shorter than the time threshold, then it will be judged as noise and the probe receiver is turned off immediately. The exploration eliminates the bad effect of noise and keeps sensitivity high. Noise will not cause the receiver to generate much extra power consumption.

In the third aspect of the present invention, the probe 200 selects a suitable structure for the receiver 201 to decrease the average power consumption much more.

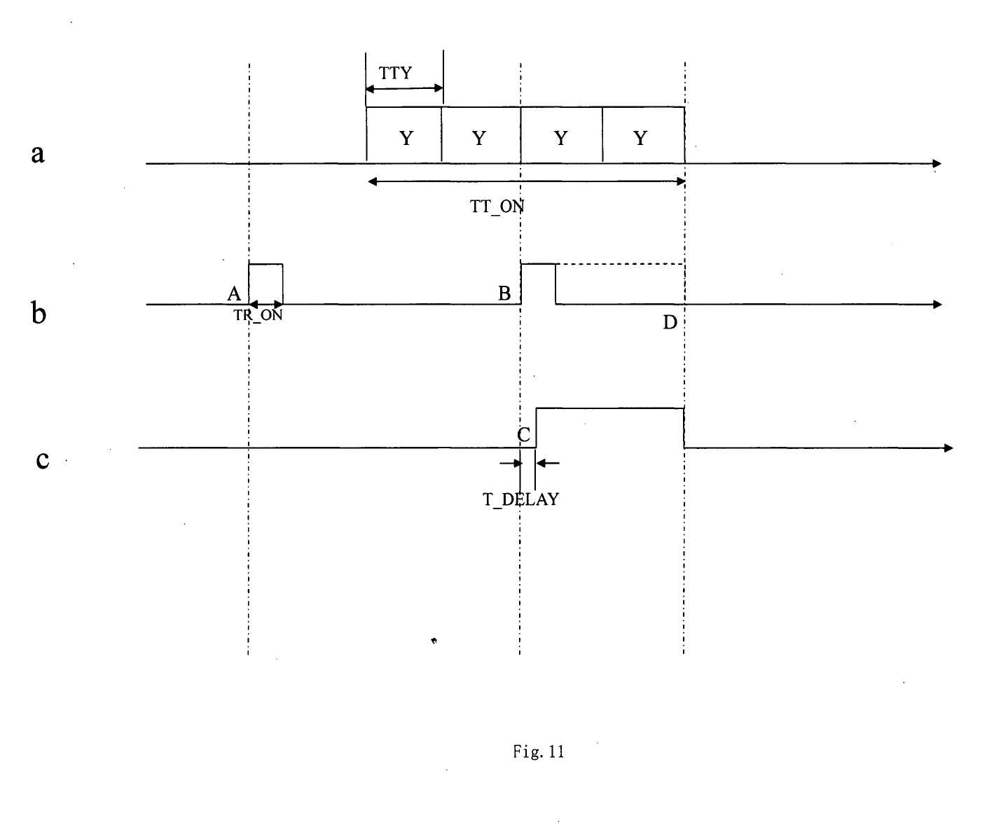

As shown in the FIG. 11(b), at the moment point A and B, the probe receiver 201 is controlled by the timer 202, the power is turned on and starts to receive and search for signals in the channel. As shown in the FIG. 11(a), at point A, the control center has not transmitted signal. As shown in the FIG. 11(c), the receiver has not received signal in the channel. At point B, as shown in the FIG. 11(a), the control center 104 is transmitting, and the receiver 201 in the FIG. 11(c) receives signal in the channel at point C. Obviously, comparing point B with point C, point C has a little delay. Since that, we define the different between point B and point C as the receiver's power-on latency time T_DELAY. The power-on latency time T_DELAY will restrict the reduction of TR_ON.

The receiver commonly used today is either super-heterodyne or direct-conversion, both of which have frequency changer structure. Frequency changer means having a mixing of an input signal and a high purity local oscillator, shifting the input signal frequency to a low frequency band and then amplification and filtering. Because of the requirement of high purity, the local oscillator has at least a selecting frequent circuit with high Q factor. For instance, use crystal whose Q factor is lager than 10000. From powering on to oscillating steadily, the local oscillator needs a start-up time. The start-up time is proportional to the Q factor. The bigger the Q factor is, the longer the start-up time takes. The local oscillator also probably needs frequency divider, phase lock and calibrate, making it longer time to stabilize the local oscillator.

Besides, mixer will cause multiple frequencies. Narrow band-pass filter or low-pass filter are necessary behind the mixer. The front-end amplifier usually has a band-pass filter. These filters will delay the signal, especially the narrow band-pass filter, with high Q factor, delay the signal more.

Because of the two reasons above, receiver with frequency changer commonly used has a long power-on latency time T_DELAY, which is more than 2 ms.

The present invention provides a receiver without frequency changer, local oscillator, band-pass, and low-pass filter to short the power-on latency time much more (the local oscillator means an oscillator of receiver whose oscillating signal frequency differs by an intermediate frequency from the input carrier signal frequency.)

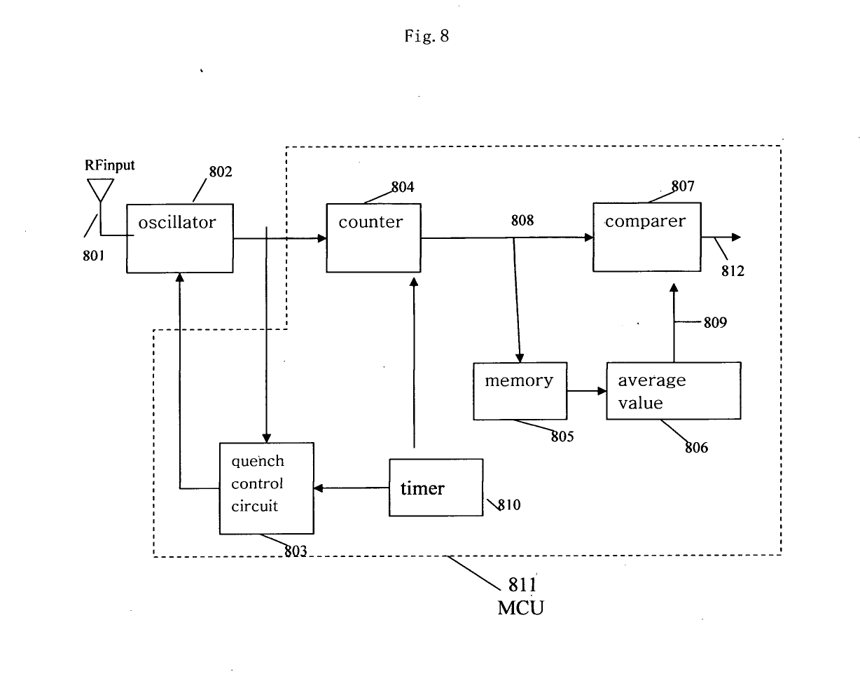

As shown in the FIG. 8, the best embodiment of the present invention employs an improved super-regenerative receiver circuit which has a very short power-on latency time T_DELAY.

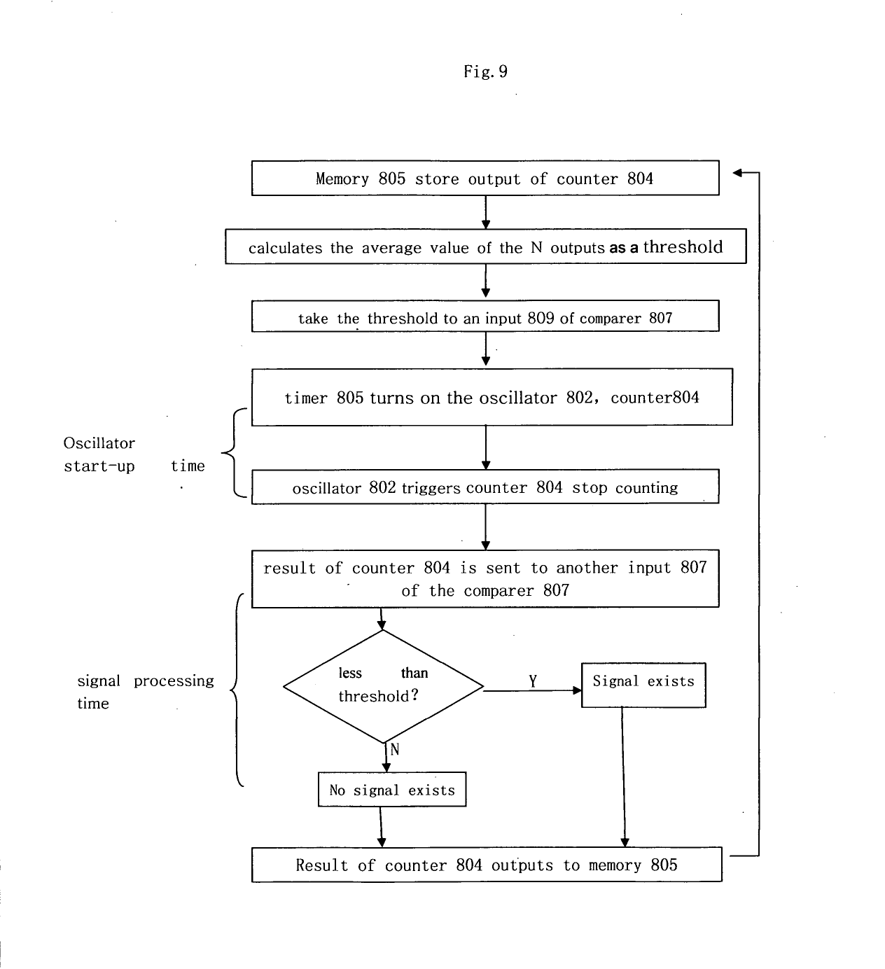

The circuit work flow is shown in the FIG. 9.

Output of the counter 804 is stored in memory 805. All previous N (for example, N=8)counter outputs are also stored in memory. The averaging circuit 806 calculates the average value of the N outputs. Take a value less than the average value to an input terminal 809 of the comparer 807, as the threshold of the comparer.

According to the principle of the super-regenerative receiver, the start-up time of the oscillator 802 depends on whether the antenna 801 has received a same frequency signal as the oscillator. If it has, the start-up time will be shorter. The circuit in the FIG. 8 detects the oscillator 802's start-up time to judge whether there is signal received by antenna 801.

The high level output of timer 810 controls the quench circuit 803 to turn on the oscillator 802, and the counter 804 to start counting. When oscillator starts oscillation and the amplitude is large enough, the counter 804 is trigger to stop counting and the quench circuit turns off the oscillator.

At this moment, the result of the counter 804 corresponds to the oscillator's start-up time, and the power-on latency time T_DELAY.

Take this result of the counter to another input terminal of the comparer 807, and compare it with the threshold in the input terminal 809.

If the result is less than the threshold, signal input and logic 1 is judged. Otherwise none signal input and logic 0 are judged.

The recent output of the timer 804 will be sent to the memory 805 and cleared.

As shown in the FIG. 9, power-on latency time of the circuit T_DELAY=start-up time 901+ signal processing time 902. Because no frequency changer, no narrow band-pass filter or low-pass filter are needed, start up time is shorter, signal processing time is shorter.

Therefore, the power-on latency time T_DELAY of the circuit is short, which is approximately less than 10 us.

If the frequency of the oscillator 802 is too high, such higher than 30 MHz, that the counter 804 can't respond in time, a envelope detector made of a diode, a resistance and a capacitance can be added behind the oscillator 802. Amplitude envelope triggers the counter 804 and turn off the oscillator 802. Apparently, the detector won't cause the change of power-on latency time T_DELAY if the capacitance small enough and the resistance large enough.

The super-regenerative receiver of this best embodiment can be used as the receiver of the probe. When detecting if signal in the channel, the timer also uses as the quench circuit of the super-regenerative receiver. As shown in the FIG. 8, the timer counter, the memory and the average circuit can be embedded into the microprocessor MCU 811 to realize their function. Under the control of timer in the MCU, when the receiver is in power-off time period, only the timer is active while MCU sleeps, when the receiver is in power-on time period, MCU is awaked by the timer and become active.

As said above, when the control center sends signals, it will continuously repeat to send signals during the time TT_ON. The receiver 201 is controlled by the timer 202, works on turned on/turned off mode. When being turned on, the receiver first detect if there is signal in the channel, depends on the detecting result, as shown in the FIG. 4(c), when there is signal in the channel, keeps power on for time period TT_ON, to receive a whole package of data; as shown in the FIG. 4(d). When there is no signal, the receiver will be turned off immediately. The power-off time period is named TT_OFF. The cycle continues and repeats. Every day, almost all situations are the same as in the FIG. 4(d) which has no signal in the channel.

In order to receive signal, according the definition of power-on latency time, the power-on time period of the receiver must be longer or equal to power-on latency time, which means:

TR_ON≧T_DELAY. (8)

Comparing with the receiver used common, the best embodiment above has greatly cut T_DELAY to under 500 us. Thus TR_ON can be reduced greatly. According to the equation (1), reducing TR_ON can cause the reduction of average energy. The energy reduction in the receiver is proportional to the reduction in T_DELAY.

If the oscillator in FIG. 8 employs LC oscillating circuit, for low Q-factor of LC circuit, LC oscillating will have a short start-up time period which is beneficial to shorten power-on latency time T_DELAY. However, frequency stability of LC circuit is poor. Selectivity and sensitivity become worse. LC circuit loses its use. Common frequency stabilization approach is use component with high Q-factor being hundred of times of LC circuit, such as quartz crystal, surface acoustic wave resonator. The oscillator is tuned in the center frequency of the high Q-factor stabilizing frequency component. Therefore, the frequency stability of the oscillating circuit will be very high, selectivity and sensitivity will be good. However, the oscillator has longer start-up time because of high Q-factor. That becomes disadvantage to the goal of shortening power-on latency time T_DELAY. The oscillator in this embodiment use the method as follow: the oscillator does not oscillate exactly in the center frequency of stabilization frequency component, it tunes near the center frequency instead. For example, higher than the center frequency 10˜100 k, it will stabilize oscillating circuit well like the common one, and start-up time will become short. This approach has advantage of stabilizing frequency without lengthening power-on latency time.

In the above aspects of the present invention, power consumption of the receiver has been reduced by orders of magnitude. The receiver can be included in the probe but hardly increase the power consumption. Thus, the probe knows when to be armed and when to be disarmed and can turn off the sensor and the transmitter in unarmed time to lower the power consumption and respond to the control center in time, realizing the goal of only being powered by the solar cell.

Generally, data transferred by the probe are few. If a lot of data are to be received or transmitted, one more receive may be constructed in the probe. One of the receivers has the structure of above, when receiving the signal from the transmitter, another receiver can be turned on. This receiver has frequency changer structure to achieve the best effect in high speed data transmission.

Obviously, all the above three aspect method that lower the power consumption of the probe receiver are not limited in the use of the wireless intruder alarm system, but can be used in all receivers that receive shot data packet transmitted randomly, to lower energy consumption greatly.

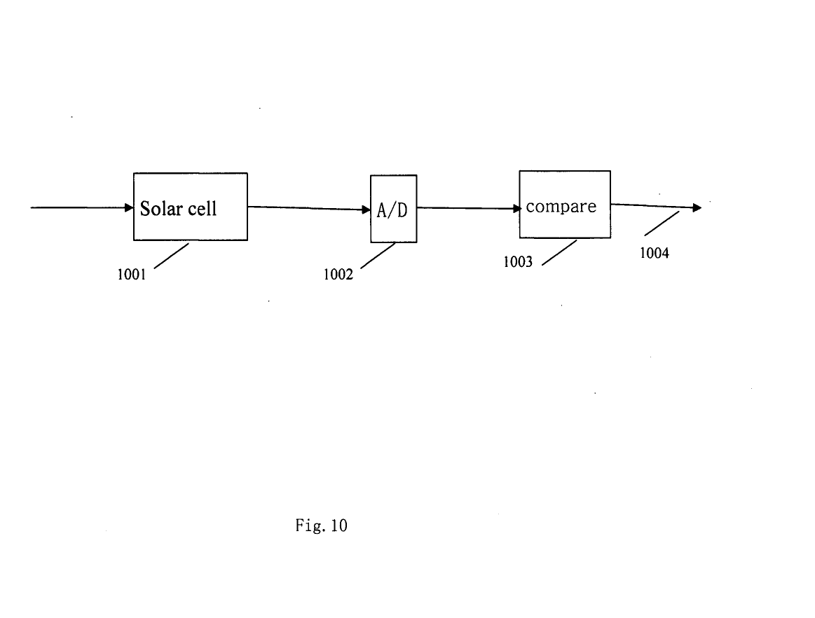

There is a HMI (human-machine interface) in the probe. As shown in the FIG. 10, the voltage of the solar cell 1001 is read through A/D converter 1002 and compared with comparator 1003. Then it will harvest a light intensity value and display it by the HMI (human-machine interface), preventing the probe from being installed in a too dark environment when being installed it.

### MODE FOR INVENTION

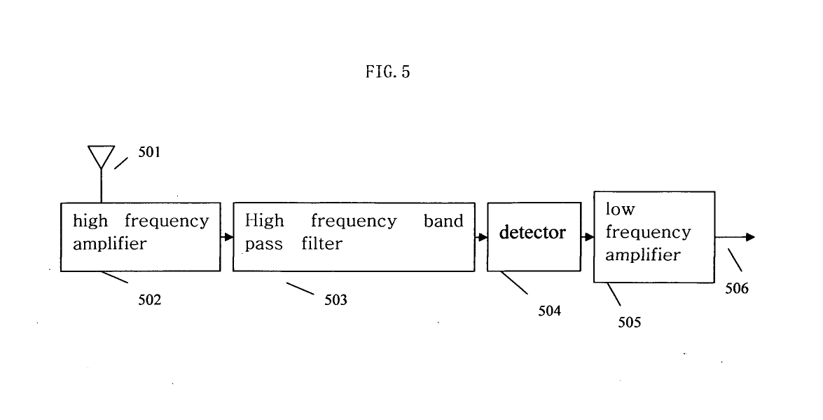

As shown in the FIG. 5, it is an embodiment of the probe receiver provided by the present invention. It is a tuning amplification receiver. The signal from antenna 501 passes high frequency low noise amplifier 502, high frequency band pass filter 503, non-linear envelope probe 504 and low frequency amplifier 505, then output 506. When the antenna 501 has received input carrier signal, the output will be a high level voltage 506. When the antenna 501 hasn't received the signal, a low level voltage 506 will be generated.

Nonlinear envelope detector 504 will lose the signal frequency and phase information. Thus the present embodiment only receives amplitude information of input signal. The frequency of input signal in the present embodiment has not been changed. As a result, the receiver is
(1) without the local oscillator, then without the start-up time of the oscillator,
(2) without mixer, then without narrow band-pass filter, low-pass filter.

Thus the receiver is without the delay made by them.

Because the cut off frequency of the high-pass filter 503 is much higher than that of the low frequency filter, the delay of the high-pass is much shorter than that of the low-pass filter. The power-on latency time of the embodiment is much shorter than that of the receiver commonly used, approximately less than 10 us. This circuit can be used as receiver 201 of the probe 200, which is turned on/turned off by timer 202 of the probe 200.

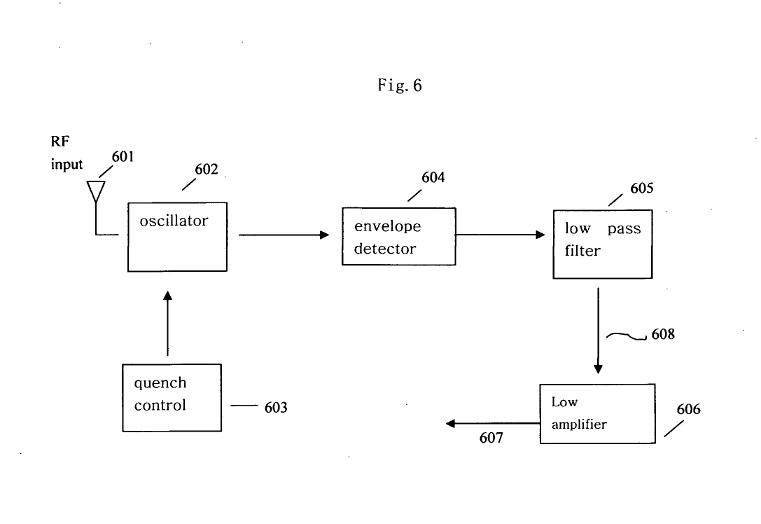

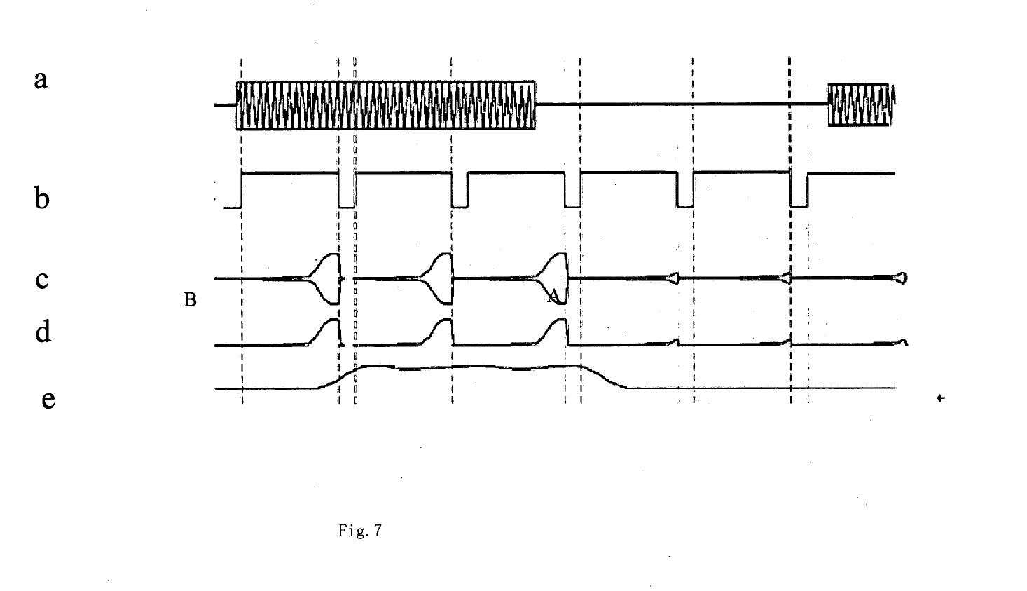

As shown in the FIG. 6, it is another embodiment of the receiver. It is a traditional super-regenerate receiver without frequency changer. Its oscillator 602 is a simple LC oscillator with a not too high Q-factor, having a short start-up time. The oscillator's start-up time will be shorter when the frequency of the LC loop is the same as the signal frequency received by the antenna 601. As shown in the FIG. 7(c) point A, when no the same frequency signal input, the oscillator is excited by thermal noise. As shown in the FIG. 7(c) point B, when the same frequency signals is input, the oscillator is excited by the input signal, the oscillation starting-up time is shorter. Quench control circuit 603 produce a switching signal, making oscillator 602 keep in the state of turn-off and oscillation. The envelope detector 604 removes the high frequency RF signal, generates pulse width modulation signal (PWM) which has the same frequency as quench signal, as shown in the FIG. 7(d). After low pass filter 605, low-frequency signal is detected, as shown in the FIG. 7(e). Without frequency transformation, the power-on latency time in the present circuit is short. So this circuit can work as the receiver 201 of the probe 200, and the output of the probe 200's timer 202 acts as the quench control signal, turning on/turning off the oscillator 602.

With a low-pass filter 605 in the circuit, the power-on latency time T_DELAY fails to be the shortest.

1. A wireless surveillance system without battery replacement, comprising of at least a probe and a control center, wherein said probe at least has a receiver, a transmitter, a timer, a sensor and a control circuit;
said receiver of the probe is controlled by the timer, operating in a continuous turned on/turned off mode: when it's time for said timer to turn on said receiver, the receiver will be turned on and waits for receiving the signal sent by said control center, the power-on time period is longer than or equal to power-on latency time of the receiver; after lasting for said power-on time period, said timer turned off the receiver until lasting for a power-off time period, then the timer will restart another turned on/turned off period.

2. The wireless surveillance system without battery replacement of claim 1, wherein said on/off mode is self-adaption, and the timing of said timer varies, the power-off time varies according to the time in a day.

3. The wireless surveillance system without battery replacement of claim 1, wherein said probe further comprising of a solar cell, a storage battery; solar cell is used as energy source; when light is strong, the solar cell provides the probe working current and charges the storage battery; when it is darken, the storage battery provides the probe working current.

4. The wireless surveillance system without battery replacement of claim 1, wherein said probe can receive an order to change state from being disarmed to being armed or contrary ; during the disarmed time, the control circuit of said probe turns off the sensor, and the transmitter, stops sensing the surrounding and the data transfer.

5. The wireless surveillance system without battery replacement of claim 1, wherein said receiver of the probe first check whether there is signal in the channel when being turned on,
if not, receiver is turned off immediately, waiting until the next being turned on by the timer (202);
if there is, the probe keeps power-on and measures the duration of the signal, if the duration is greater than a certain threshold, the probe keeps power-on one more to receive the complete signal sent by the control center, or the receiver is turned off immediately, waiting until the next being turned on by the timer (202).

6. The wireless surveillance system without battery replacement of claim 1, wherein said receiver has been shortened power-on latency time to less than 500 us.

7. The wireless surveillance system without battery replacement of claim 6, wherein said receiver has no frequency changer, no intermediate frequency band-pass filter, and has no low-pass filter.

8. The wireless surveillance system without battery replacement of claim 1, wherein said receiver of the probe is a super-regenerate receiver without low pass filter.

9. The wireless surveillance system without battery replacement of claim 8, wherein said super-regenerate receiver has oscillator, timer, envelope detector, counter, comparator, memory and average value circuit; all these circuits are embedded into a microprocessor MCU.

10. The wireless surveillance system without battery replacement of claim 9, wherein said oscillator has a high Q factor component to stabilize frequency.

11. The wireless surveillance system without battery replacement of claim 9, wherein said oscillator works in the frequency offsetting the center frequency of the high Q factor component.

12. The wireless surveillance system without battery replacement of claim 1, wherein said probe includes a human-machine interface indicating the current level of light.

13. A method of controlling a wireless devices comprising, a receiver, a timer, a control circuit. wherein the method comprises: a trigger signal of the timer controlling the receiver working continuously in turned on turned off mode: when in on state, turning on the receiver into receiving for a time period that is equal to or longer than the power-on latency time of the receiver; when in off state, turning off the receiver or triggering the receiver into sleep.

14. The method of claim 13, wherein the wireless devices further comprises a transmitter, first transiting a constant amplitude signal for a time period which is longer than the power-off time of the receiver, then transiting the data content.

15. The method of claim 13, wherein the receiver first checks existence of the signal while being turned on; if inexistence, turning off the receiver immediately and waiting for the next time of being turned on; if existence, keep the receiver being powered on and measures the duration in which the signal amplitude does not change, if the duration is longer than a certain threshold, keep being powered on to receive the complete data content sent by the transmitter, or it will be turned off immediately, waiting until the next time of being turned on.

16. The method of claim 13, wherein shortening the power-on latency time of the receiver to less than 500 us.

17. The method of claim 13, wherein employing the receiver without frequency changer, intermediate frequency, band pass filter and low-pass filter to receive the signal.

18. The method of claim 13, wherein employing a super-regenerate receiver without low-pass filter to receive the signal.

19. The method of claim 13, wherein the receiver further comprises a oscillator having a high Q factor component to stabilize frequency.

20. The method of claim 19, wherein tuning the oscillator of receiver to oscillate in the frequency offsetting the center frequency of the high Q factor component.
